(19) United States
(12) Patent Application Publication
(10) Pub. No.: US 2009/0323926 A1
(43) Pub. Date: Dec. 31, 2009

(54) METHODS AND SYSTEMS FOR VOICE COMMUNICATION

(76) Inventors: Eliezer SHAHAM, Givat-Ada (IL); Gadi Guy, Elishama (IL)

Correspondence Address: Pearl Cohen Zedek Latzer, LLP, 1500 Broadway, 12th Floor, New York, NY, 10036, US

(21) Appl. No.: 12/494,359

(22) Filed: Jun. 30, 2009

Related U.S. Application Data
(60) Provisional application No. 61/076,718, filed on Jun. 30, 2008.
(60) Provisional application No. 61/140,641, filed on Dec. 24, 2008.

(51) Int. Cl. H04M 9/08; H04M 3/00

(52) U.S. Cl. 379/406.06; 379/352

(57) ABSTRACT

An intermediary communication system, the intermediary communication including: (a) a first network interface, configured for transmitting over a first network connection to a first remote end unit a first sound sequence; and for receiving from the first remote end unit a returning sound sequence that is responsive to the first sound sequence; (b) a processor, configured to determine an echo reduction parameter in response to a relationship between a first sound sequence parameter and a returning sound sequence parameter; and (c) a second network interface, for transmitting to a second remote end unit, over a second network connection, a processed sound sequence that was generated in response to the echo reduction parameter from a preprocessed sound sequence which was generated by the first remote end unit.

### CROSS-REFERENCE TO RELATED APPLICATIONS

This application claims the priority of U.S. provisional patent Ser. No. 61/076,718, filing date Jun. 30, 2008, entitled “A method, a system and a computer program product for contextual Communications”; and of U.S. provisional patent Ser. No. 61/140,641, filing date Dec. 24, 2008, entitled “Specification of bAvailable In-Place Call Technology”.

### FIELD OF THE INVENTION

The invention relates to methods and systems for voice communication.

### BACKGROUND OF THE INVENTION

Prior art communication solutions enable a user of a system to reduce echoes in a voice communication in one of the ends of the communication (i.e. by one or the parties). However, many a times it is desirable to have reliable and simple means of reducing echo by an intermediary communication unit that connects the two partied.

### SUMMARY OF THE INVENTION

A intermediary communication system, the intermediary communication including: (a) a first network interface, configured for transmitting to a first remote end unit a first sound sequence over a first network connection; and for receiving from the first remote end unit a returning sound sequence that is responsive to the first sound sequence; (b) a processor, configured to determine an echo reduction parameter in response to a relationship between a first sound sequence parameter and a returning sound sequence parameter; and (c) a second network interface, for transmitting to a second remote end unit, over a second network connection, a processed sound sequence that was generated in response to the echo reduction parameter from a preprocessed sound sequence which was generated by the first remote end unit.

A method for reducing echo, the method including carrying out by an intermediary communication system the following steps: (a) transmitting to a first remote end unit a first sound sequence over a first network connection; (b) receiving from the first remote end unit a returning sound sequence that is responsive to the first sound sequence; (c) determining an echo reduction parameter in response to a relationship between a first sound sequence parameter and a returning sound sequence parameter; and (d) transmitting to a second remote end unit, over a second network connection, a processed sound sequence that was generated in response to the echo reduction parameter from a preprocessed sound sequence which was generated by the first remote end unit.

A method for reducing echo, the method including carrying out by an intermediary communication system the following steps: (a) receiving over a second network connection from a second remote end unit a second unit sound signal; (b) processing the second unit sound signal to provide a sequence of timed sound signal segments, wherein each of the timed sound signal segments is associated with an audio parameter value and with timing information; (c) transmitting over a first network connection to a first remote end unit the sequence of timed sound signal segments, wherein each of the timed sound signal includes timing metadata that indicates the timing information associated with the timed sound signal segment; (d) receiving from the first remote end unit a first unit sound signal that includes a sequence of return sound signal segments, wherein each of the return sound signal segments includes timing metadata that is a responsive to timing information that is received by the first remote end unit before the return sound signal is generated; (e) processing a return sound signal segment for reducing echo effects in response to the audio parameter value that is associated with the timing information that is indicated in the return sound signal segment; and (f) transmitting a processed sound stream over the second network connection to the second remote end unit, wherein the processed sound stream includes processed return sound signal segments.

### BRIEF DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views, in which:

FIG. 1 illustrates a system for reducing echo in audio communication, according to an embodiment of the invention;

FIGS. 2A and 2B illustrate methods for reducing echo, according to several embodiments of the invention;

FIGS. 3A and 3B illustrate processes for reducing echo according to different embodiments of the invention;

FIG. 4 illustrates transmission of sound sequence segments, according to an embodiment of the invention;

FIG. 5 illustrates a system, according to an embodiment of the invention;

FIG. 6 illustrates a method for reducing echo, according to an embodiment of the invention; and

FIG. 7 illustrates a system, according to an embodiment of the invention.

### DETAILED DESCRIPTION OF THE DRAWINGS

This application claims the priority of U.S provisional patent Ser. No. 61/076,718, filing date Jun. 30, 2008, entitled “A method, a system and a computer program product for contextual Communications”; and of U.S provisional patent Ser. No. 61/140,641, filing date Dec. 4, 2008, entitled “Specification of bAvailable In-Place Call Technology”, both of which are incorporated herein by reference.

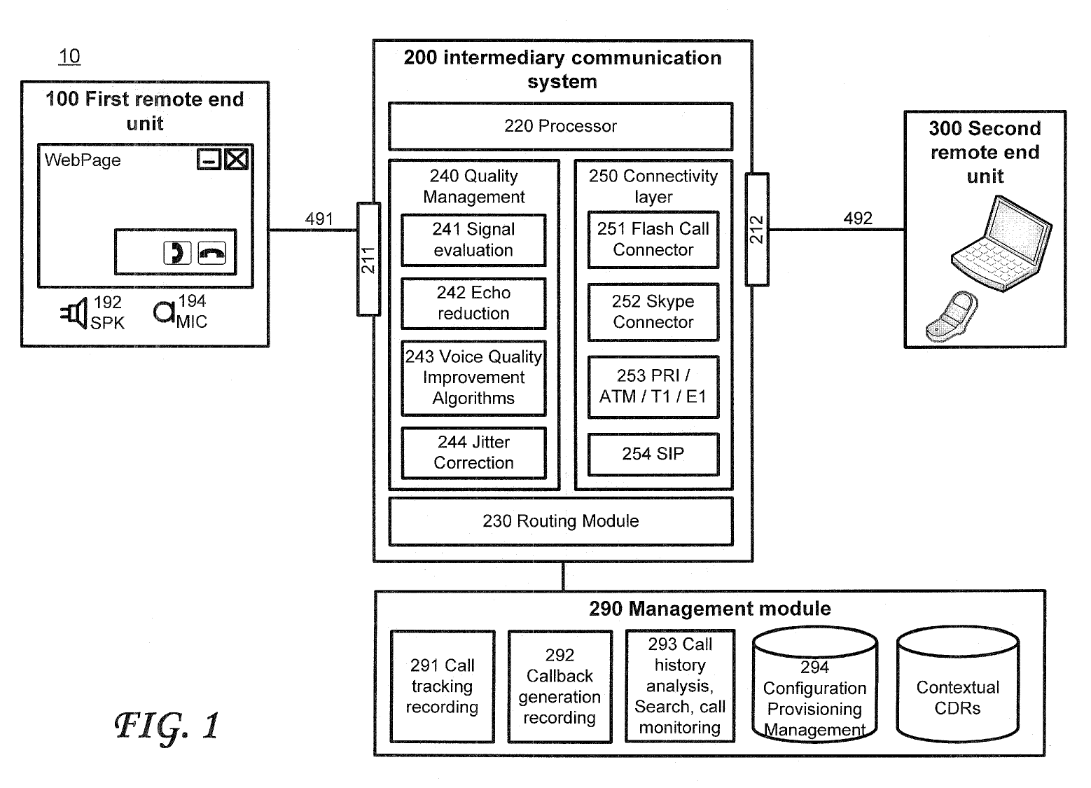

FIG. 1 illustrates system 10 for reducing echo in audio communication, according to an embodiment of the invention. System 10 includes intermediary communication system 200, and two remote end-units, first remote end unit 100, and second remote end unit 300. Each of the remote end units 100 and 300 is connected to intermediary communication system 200 over at least one network connection (e.g. internet connection), but it is noted that the different remote end units 100 and 300 may be connected to intermediary communication system 200 over different types of network. By way of an illustrative example only, first remote end unit 100 may be connected to intermediary communication unit 200 over an HTTP internet connection, while second remote end unit 300 may be connected to intermediary communication system 200 over a PSTN network connection that leads to an organizational LAN network via a corporate gateway.

According to an embodiment of the invention, at least one of the network connections is an internet protocol (IP) connection. More specifically, according to an embodiment of the invention, first remote end unit 100 is connected to intermediary communication system 200 over at least one IP connection.

As is described below in more details, intermediary communication system 200 takes a central place in reducing echo in the audio communication between the two remote end units 100 and 300, contrary to the accepted practice in prior art reduction systems, in which the echo reduction is carried out in one or both of the ends. The central place of intermediary communication system 200 in the echo reduction may be implemented in order to overcome an incapability of one or both of the remote end units 100 and 300 to do so, but this is not necessarily so.

It is known that in IP connection, a latency of the connection (the time that takes to a packet to travel from one end of the connection to the other, or a back and forth trip) is not known in advance, and varies over time. This is due, among other reasons, to an ad-hoc routing regime, in which the number of legs in the communication is not known in advance, and may change over time.

Intermediary communication system 200 includes first network interface 211, configured for transmitting to first remote end unit 100 a first sound sequence (not denoted in FIG. 1) over first network connection 491; and for receiving from first remote end unit 100 (conveniently also over first network connection 491) a returning sound sequence (not denoted in FIG. 1) that is responsive to the first sound sequence.

Intermediary communication system 200 also includes processor 220, that is configured to determine an echo reduction parameter in response to a relationship between a first sound sequence parameter (that pertains to the first sound sequence) and a returning sound sequence parameter (that pertains to the returning sound sequence).

Intermediary communication system 200 further includes second network interface 212, for transmitting to second remote end unit 300, over a second network connection 492, a processed sound sequence (not denoted in FIG. 1) that was generated in response to the echo reduction parameter from a preprocessed sound sequence (not denoted in FIG. 1) which was generated by the first remote end unit 100. It is noted that the processed sound sequence may be generated by intermediary communication unit 200, and may also be generated by first remote end unit 100, or by collaboration of both systems.

It is noted that first and second networks connections 491 and 492 may be connections over the same network (e.g. Internet), but this is not necessarily so.

According to an embodiment of the invention, first network interface 211 is further configured for transmitting the first sound sequence over at least one asynchronous packet switched network segment.

According to an embodiment of the invention, processor 220 is further configured to digitally process, prior to a receiving of the returning sound sequence, sound signals received in an incoming channel of intermediary communication system 200, for detecting the returning sound sequence.

According to an embodiment of the invention, a delay between a transmission of the first sound sequence and a reception of the returning sound sequence is not known prior to a determination of the echo reduction parameter by processor 220.

According to an embodiment of the invention, processor 200 is further configured to determine a delay period between a transmitting time of the first sound sequence and a reception time of the returning sound sequence (For example by way of correlating the spectral signature of the transmitted and returned audio sequence, or comparing the frequency histograms or a derived, transformed or modulated instance of the frequency histograms of the transmitted and received sequences); wherein first network interface 211 (and system 200 generally) is further for transmitting over first network connection 211 to first remote end unit 100, prior to the transmitting of the processed sound sequence, a second sound sequence, after the determining of the delay period; and wherein processor 220 is further configured to process the preprocessed sound sequence in response to the delay period and in response to the second sound sequence, to provide the processed sound sequence. According to an embodiment of the invention, the delay period is larger than 300 milliseconds. According to an embodiment of the invention, the second sound sequence is responsive to a sound sequence that is received from the second remote end unit.

According to an embodiment of the invention, intermediary communication system 200 (and conveniently, processor 220 and/or second network interface 212 especially) is further configured to prepare the processed sound sequence for transmission to a circuit switched telephony system remote end unit (acting as second remote end unit 300).

According to an embodiment of the invention, processor 200 is further configured to periodically update, following a determining of the echo reduction parameter, the echo reduction parameter in response to an analysis of sound signal that is received from first remote end unit 100, and wherein processor 220 is further configured to utilize the updated echo reduction parameter for processing a preprocessed sound signal that is generated by first remote end unit 100 (e.g. in a later time than a processing of a previous preprocessed sound sequence).

According to an embodiment of the invention, first network interface 211 is further for receiving the preprocessed sound sequence from the first remote end unit which does not perform echo reduction; processor 220 is further configured to process, prior to a transmitting of the processed sound sequence to second remote end unit 100, the preprocessed sound sequence in response to the echo reduction parameter, to provide the processed sound sequence; and second network interface 220 is further for transmitting the processed sound sequence to the second remote end unit that does not perform echo reduction on the processed sound sequence.

According to an embodiment of the invention, intermediary communication system 200 is further configured to provide the echo reduction parameter to first remote end unit 100, and to receive the processed sound sequence from first remote end unit 100 prior to a transmitting of the processed sound sequence to second remote end unit 300.

According to an embodiment of the invention, first network interface 211 is further configured to transmit multiple first sequence segments that include transmission timing metadata that indicate transmission timing of the first sequence segments; and to receive multiple returning sequence segments that include return timing metadata that is incorporated into the returning sequence segments by first remote end unit 200 in response to the transmission timing metadata received by first remote end unit 100; wherein processor 200 is further configured to determine the echo reduction parameter in response to a comparison between the return timing metadata and a reception timing of the returning sound sequence.

According to an embodiment of the invention, first network interface 211 is further configured to receive the returning sound sequence within a superimposed stream that is superimposed by first remote end unit 100 from first unit input sound that is detected by first end unit microphone 194 and from sound that is received by first remote end unit 100 from the intermediary communication system 200; and wherein processor 220 is further configured to determine the echo reduction parameter in response to a detecting of echo effects within the returning sound sequence.

It is noted that, according to an embodiment of the invention, intermediary communication system 200 may provide at least one of first and second remote end units 100 and 300 (and/or to a third party system) information pertaining to the echo reduction parameter or other information pertaining to a voice conversation between first and second remote end units 100 and 300.

According to an embodiment of the invention, intermediary communication system 200 includes routing module 230 that is configured at least for routing conversation packets of the voice communication session. It is noted that routing module 230 may be a part of (or otherwise related to) a contextual call routing layer, but this is not necessarily so.

For example, the incoming voice communication calls can be routed through one or more of the following options/scenarios:
a. Connected to second remote end unit 300;
b. Placed on hold.
c. Served music and other media files out of a repository of media files.
d. Served contextually targeted audio advertising out of a repository of available audio ads stored at a database or retrieved from an external content owner.
e. Caller (user of remote system 100) can be presented an audio IVR menu for selection of different routing choices via DTMF.
f. Caller can be routed to different phone numbers, e.g. Skype, VoIP trunks or other communication widgets 420 that are configured as means of communicating the intended receiving party.
g. Caller can be routed and bridged with access numbers that lead to external IVR applications (for instance IVR applications that are part of an advertiser's call center).

According to different embodiments of the invention, intermediary communication unit may include additional components such as components 240, 250, 290, and so forth. Such components are disclosed, for example, in U.S. patent entitled “Method and system for providing communication” by the same inventors, filing date Jun. 30 2009, which is incorporated herein by reference.

It should be noted that conveniently, intermediary communication system 200 is configured to carry out at least one embodiment of method 500 disclosed below, and that different embodiments of method 500 may be implemented by intermediary communication system 200, even if not explicitly elaborated.

It should be noted that conveniently, intermediary communication system 200 is configured to carry out at least one embodiment of method 600 disclosed below, and that different embodiments of method 600 may be implemented by intermediary communication system 200, even if not explicitly elaborated.

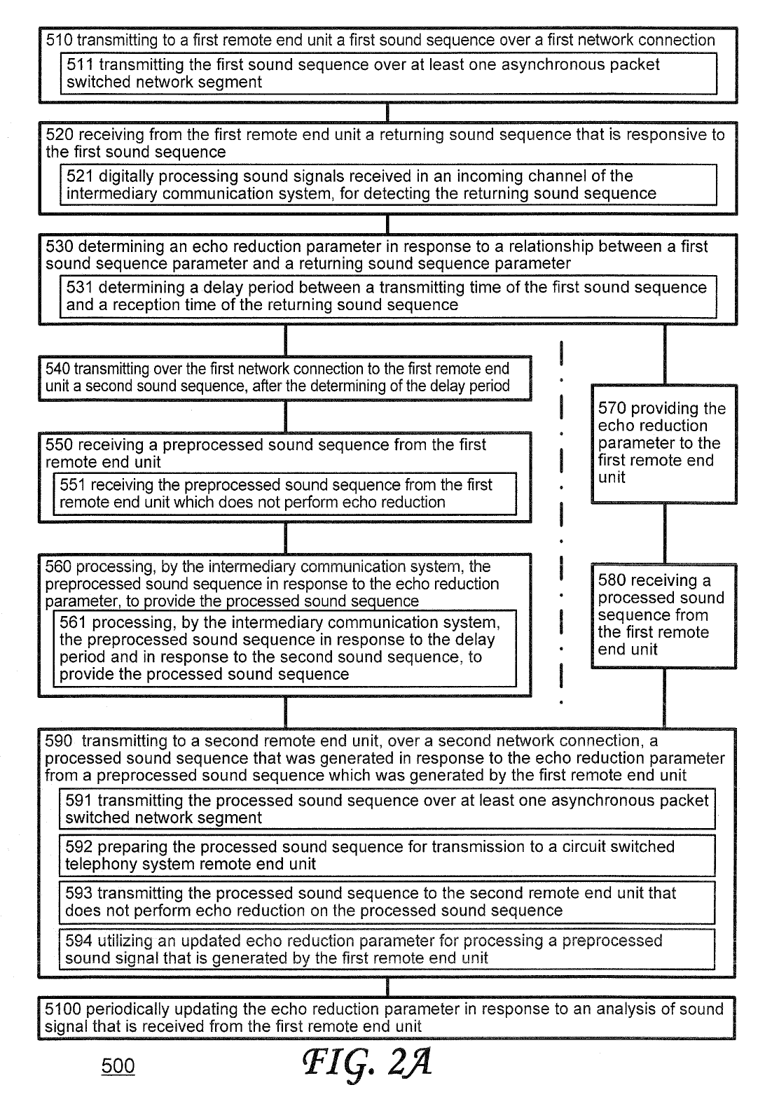

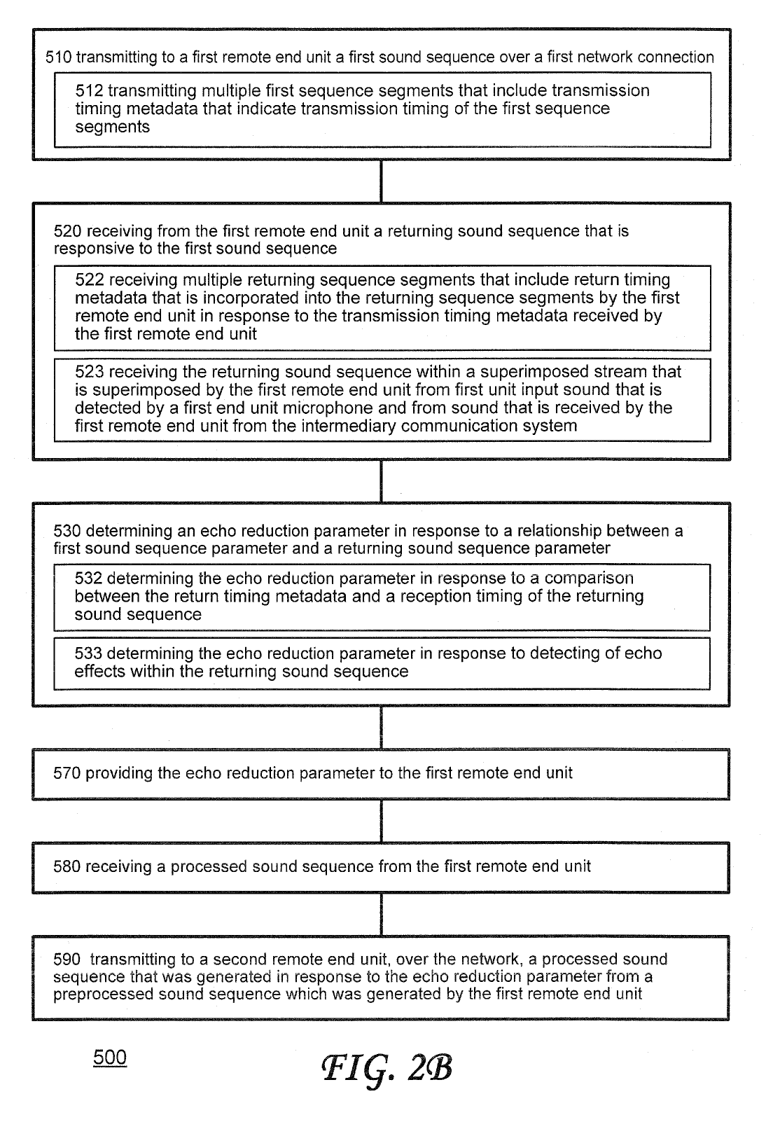

FIGS. 2A and 2B illustrate method 500 for reducing echo, according to several embodiments of the invention. Referring to the examples set forth in the previous drawings, method 500 may be carried out according to an embodiment of the invention in a system such as system 10 of FIG. 1. It is noted that conveniently, all of the stages of method 500 (unless otherwise stated) are carried out by an intermediary communication system—such as a communication server—but this is not necessarily so.

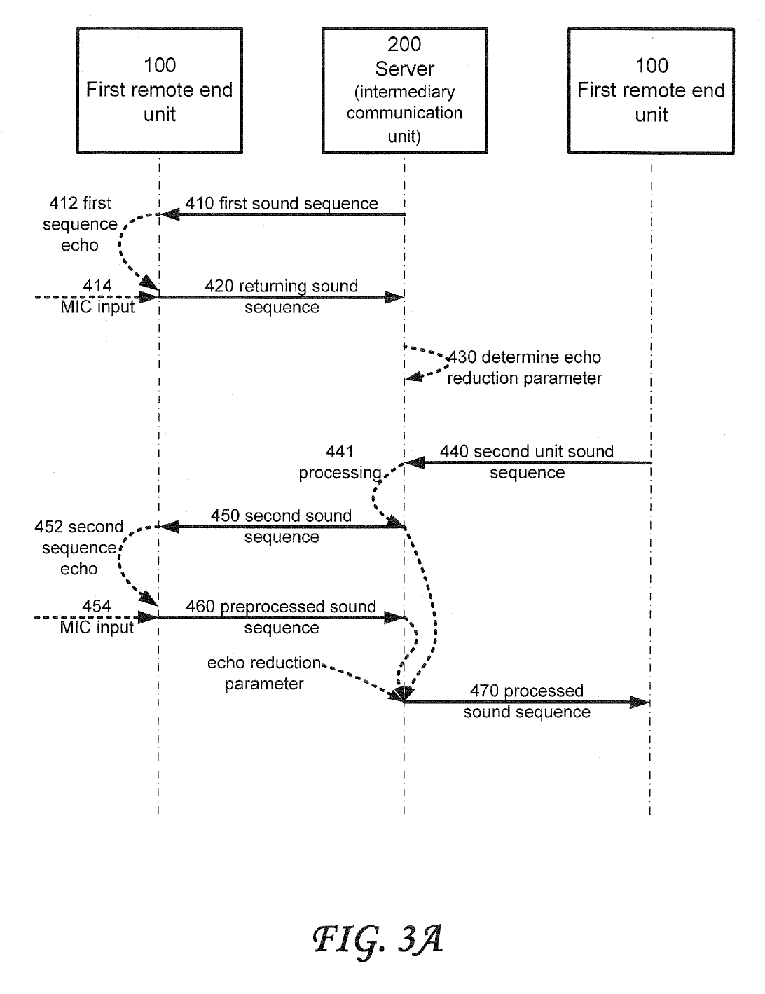

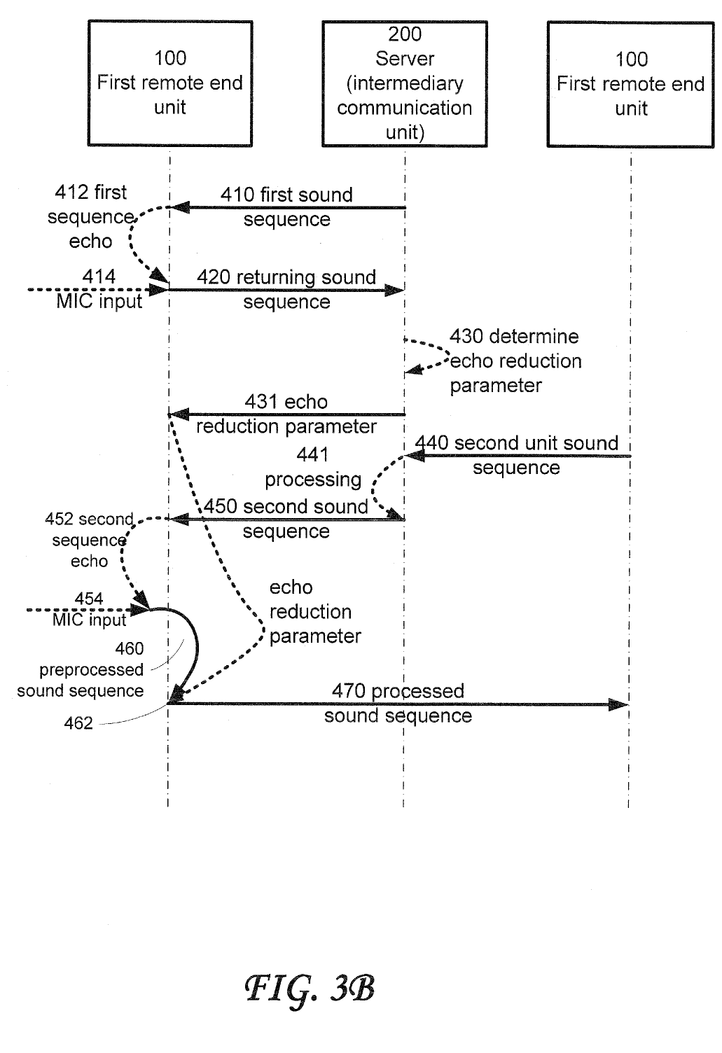

For the convenience of explanation, the description of method 500 will be accompanied by reference numbers that are related to the process diagram of FIG. 3. It is however noted that the referencing to FIG. 3 is relevant only to some of the embodiments of method 500, and is not intended to limit the scope of the invention in any way.

Method 500 conveniently starts with step 510 of transmitting to a first remote end unit a first sound sequence 410 over a first network connection. According to an embodiment of the invention, first sound sequence 410 is dedicated for the determining of echo reduction parameters, but this is not necessarily so. It is noted that according to an embodiment of the invention, first sound sequence 410 is a ‘signature’ short audio track (e.g. a 100 ms length or so sized audio file).

It is noted that first sound sequence 410 is conveniently designed so an echoing of which would be detectable at a future time (i.e. at a return audio channel), even if it would be superimposed with another sound (usually with background noise). For example, first sound sequence 410 may include audio signals that vary in amplitude and frequency in a way that can be easily distinguishable from carrier signal or common background noise.

As aforementioned, according to an embodiment of the invention, the first remote end unit is connected to the intermediary communication system 200 over at least one IP connection. According to an embodiment of the invention, step 510 includes step 511 of transmitting first sound sequence 410 over at least one asynchronous packet switched network segment. It is noted that asynchronous packet switched network are characterized in changing latency, thus hindering many echo reduction algorithms.

Step 510 is followed by step 520 of receiving from the first remote end unit a returning sound sequence 420 that is responsive to first sound sequence 410. It is noted that assumedly both a speaker 192 and a microphone 194 of first remote end unit 100 are operative (since those are needed for a voice conversation with the second remote end-unit). Echoes (and other acoustic effects such as reverberations) results from sound being reflected back to the listener; in this case sound that is provided from the intermediary communication system may be emitted by speaker 192 of first remote end unit 100 and may be received by microphone 194 (either directly—usually having the loudest effect—or returning from objects in the surroundings of the first remote end unit), and transmitted back to the intermediary communication system, towards the second remote end unit. Such returning sound may be superimposed with other sounds that are acquired by microphone 194 (e.g. background noise, background music, speech, etc.). It is noted that returning sound sequence 420 may include first sequence echo 412 (and more specifically, it may also include several echoes) that is responsive to first sound sequence 410, as well as microphone input 414 (which includes sound signals other then echoes of first sound sequence 410 which are detected by microphone 194).

It is noted that, according to an embodiment of the invention, step 520 includes step 521 of digitally processing, prior to the receiving of returning sound sequence 420, sound signals which are received in an incoming channel of the intermediary communication system, for detecting returning sound sequence 420. It is noted that conveniently, first sound sequence 410 includes signature pattern, which is recognizable when being echoed back to microphone 194, and over an acceptable level of background signals 414.

As in step 511, it is noted that, according to an embodiment of the invention, the receiving of returning sound sequence 420 may include receiving the returning sound sequence 420 over at least one asynchronous packet switched network segment (which is usually the same asynchronous packet switched network segment of stage 511, even though the routing within the network segment may differ). It is noted that in the term network segment, it should be understood that information may be transmitted over more than one network segment (e.g. LAN and wireless network), in which case each of the different networks (or relevant portions thereof) may be considered as a network segment.

Step 520 is followed by step 530 of determining an echo reduction parameter in response to a relationship between at least one first sound sequence parameter and at least one returning sound sequence parameter, wherein the at least one first sound sequence parameter pertains to first sound sequence 410, and the at least one returning sound sequence parameter pertains to returning sound sequence 420. It is noted that different types of parameters may be implemented in different embodiments of the invention, and that while usually the type of parameters used for the first sound sequence parameter is the same as the one used for the returning sound sequence parameter, this is not necessarily so.

For example, some types of parameters that may be implemented art: time of transmission/reception, frequencies, gain, spectral analysis parameters, and so forth. Conveniently, the echo reduction parameter determined in step 530 is useful for at least one of determining the timing when echoes should be reduced, and determining audio parameters for the reduction of echoes.

It is noted that, according to an embodiment of the invention, multiple first sound sequences 410 and multiple respective returning sound sequences 420 for determining at least one echo reduction parameters, mutatis mutandis.

It is noted that, according to an embodiment of the invention, the delay between a transmission of the first sound sequence and a reception of the returning sound sequence is not known prior to the determining of the echo reduction parameter. This is usually do to characteristics of the first network connection (e.g. being an IP connection, where latency is not known in advance).

According to an embodiment of the invention, step 530 includes step 531 of determining a delay period between a transmitting time of first sound sequence 410 and a reception time of returning sound sequence 420 (for example by way of correlating the spectral signature of the transmitted and returned audio sequence, or comparing the frequency histograms or a derived, transformed or modulated instance of the frequency histograms of the transmitted and received sequences.). Once the delay period have been determined, sampling the sound signals that are transmitted to the first remote end unit may be used for reducing echoes of those sound signals at incoming sound signals that are received after such a delay period passes. That is, if the delay period is determined to be ΔT, than if the intermediary communication system samples a certain value V₁ for a sound sequence that is transmitted to the first remote end unit at time T₁, than the value V₁ may be used for reducing echo from sound sequence that is received from the first remote end unit at time T₁+ΔT, or at a time in the proximity thereof (given that the latency may vary over time).

The echo reduction parameter of step 530 is used for reducing echo in sound signals that are transmitted from the first remote end unit to the second remote end unit via the intermediary communication system, so that in step 590 a processed sound sequence 470 that was generated in response to the echo reduction parameter from a preprocessed sound sequence which was generated by the first remote end unit can be transferred to the second remote end unit.

It is noted that according to different embodiments of the invention, once the echo reduction parameter have been determined by the intermediary communication system (and not in one of the end units), it may be utilized by either the first remote end unit or the intermediary communication unit for reducing echo. It is noted that one or more echo reduction parameters may be used for reducing echo in both the first remote end unit and the intermediary communication unit. Also, according to an embodiment of the invention, the second remote end unit may participate in (or carry out) echo reduction using the determined echo reduction parameter.

According to an embodiment of the invention, the echo reduction parameter is utilized by the intermediary communication unit for reducing echo in sound signals—such as preprocessed sound sequence 460 of FIG. 3A—which are transmitted from the first communication end unit to the second communication end unit via the intermediary communication system.

According to an embodiment of the invention, the determining of the echo reduction parameter is followed by step 540 of transmitting over the first network connection to the first remote end unit a second sound sequence 450. Usually, the second sound sequence 450 is responsive to a second unit sound sequence 440 that is received from the second remote end unit (e.g. a voice sample of a user of the second remote end unit, that is to be played to a user of the first remote end unit), possibly after some processing, but it is noted that other second sound sequences 450 may be provided from other source. For example, the intermediary communication system may initiate voice messages to the first remote end unit.

According to an embodiment of the invention, the second sound sequence 450 is responsive to a sound sequence (such as sound unit sound sequence 450) that is received from the second remote end unit.

Step 540 is followed by step 550 of receiving a preprocessed sound sequence 460 from the first remote end unit. It is noted that the preprocessed sound sequence 460 is responsive both to an echoing of the second sound sequence 460 (denoted second sequence echo 452) and to other sound signals that are detected by the microphone of the first remote end unit (denoted MIC input 454, such as talking of the user of the first remote end unit). It is noted that the receiving of the preprocessed sound sequence 460 is usually determined by detecting the relevant preprocessed sound sequence 460, either in response to the previously determined delay period, or by digitally processing sound signals received in the incoming channel of the intermediary communication system

According to an embodiment of the invention, the receiving of step 550 includes step 551 of receiving the preprocessed sound sequence 460 from the first remote end unit which does not perform echo reduction.

Step 550 is followed by step 560 of processing, by the intermediary communication system, the preprocessed sound sequence 460 in response to the echo reduction parameter, to provide the processed sound sequence 470.

It is noted that the processing of the preprocessed sound sequence 460 in step 560 is usually responsive to the second sound sequence 450 (since an echoing of which is to be reduced from the preprocessed sound sequence 460) as well as to the echo reduction parameter (not numbered in FIG. 3A).

According to an embodiment of the invention, step 560 includes step 561 of processing, by the intermediary communication system, the preprocessed sound sequence 460 in response to the delay period and in response to the second sound sequence 450, to provide the processed sound sequence. For example, the processing of step 560 may include reducing a gain of the preprocessed sound sequence 460 that is received at time T₁+ΔT, by a value that is determined from processing the second sound sequence 450 which was transmitted at time T₁. It is noted that the processing of the second sound sequence 450 may include for example, determining an over all gain of the second sound sequence 450, or analyzing the gain of the second sound sequence 450 at different frequencies, according to a diagnosis filter (which may be determined at stage 530, e.g. analyzing how different frequencies are echoes from the first remote end unit).

Referring to method 500 in general, and especially to steps 531 and 561, it is noted that the delay period determined is usually considerably longer than delay periods that are relevant to reducing echo within a remote end unit. Considering a local reduction of echoes, the time that a sound travels between a speaker and a microphone of a single system (e.g. a telephone, a personal computer) is usually very short—e.g. few milliseconds and even shorter—shorter than a millisecond.

However, since the echo reduction according to the teaching of the invention may be carried out in intermediary communication system 200, the delay period determined and utilized may be significantly longer. For example, according to an embodiment of the invention, the delay period is larger than 300 milliseconds (and the determining of the delay period includes determining a delay period that is larger than 300 ms). According to an embodiment of the invention, the delay period is larger than 50 milliseconds. According to an embodiment of the invention, the delay period is larger than 100 milliseconds. According to an embodiment of the invention, the delay period is larger than 600 milliseconds.

As aforementioned, according to an embodiment of the invention, the processing of the preprocessed sound sequence may be carried out by the first remote end unit. According to an embodiment of the invention, step 530 is followed by step 570 of providing the echo reduction parameter to the first remote end unit (denoted 431), which is followed by step 580 (that is carried out prior to step 590) of receiving the processed sound sequence 470 from the first remote end unit. It is noted that while the first remote end unit carried out echo reduction, the determination of the echo reduction parameter that enables such echo reduction is carried out by the intermediary communication unit.

Referring to FIG. 3B, it is noted that the first remote end unit processes the preprocessed sound sequence 460 in response to the echo reduction parameter locally (denoted 462).

It is further noted that, according to an embodiment of the invention, all of stages 540, 550, 560, 570, and 580 are carried out, when both the first remote end unit and the intermediary communication unit participate in an echo reduction process. It is noted that those systems may use either the same at least one echo reduction parameter, and/or at least one echo reduction parameter that is different between those two systems. For example, according to an embodiment of the invention, the processed sound sequence of stage 580, which is processed by the first remote end unit, may serve as a preprocessed sound sequence for a processing of stage 560 by the intermediary communication unit.

Method 500 continues with step 590 of transmitting to the second remote end unit, over the second network connection, processed sound sequence 470 that was generated in response to the echo reduction parameter from a preprocessed sound sequence 460, wherein the preprocessed sound sequence was generated by the first remote end unit.

According to an embodiment of the invention, step 590 includes step 591 of transmitting the processed sound sequence 470 over at least one asynchronous packet switched network segment.

It is noted that different embodiments of the invention, different types of second remote end units may be supported, such as legacy telephone systems, cellular phones, smart phones, personal computers, corporate switch board and so forth. Supporting different types of second remote end units may require preparing the processed sound sequence 470 to be received by a certain type of second remote end unit, and/or preparing it to be transmitted over a certain type of network.

For example, according to an embodiment of the invention, step 590 includes step 592 of preparing the processed sound sequence 470 for transmission to a circuit switched telephony system remote end unit.

According to an embodiment of the invention, step 590 includes step 593 of transmitting the processed sound sequence 470 to the second remote end unit that does not perform echo reduction on the processed sound sequence 470.

It is noted that, according to an embodiment of the invention, method 500 further includes step 5100 of periodically updating the echo reduction parameter in response to an analysis of sound signal that is received from the first remote end unit. That is, following the determining of the echo reduction parameter in step 530, the echo reduction parameter may be periodically updated, to allow better echo reduction later in time. It is noted that the parameters of echoes may change over time, due to both physical (e.g. location of microphone 194 in relation to speaker 192) and communicational (e.g. routing of information) causes.

It is noted that the updating may be incremental (e.g. depending on previously determined values of the echo reduction parameters) and may also be determined without relying on such previous determinations. Also, it is noted that the updating may be carried out by analyzing sound/data that is transferred between the intermediary communication system and the first remote end unit as part of a voice communication, and may also require transmitting a dedicated signal (e.g. similar to first sound sequence 410).

The updated echo reduction parameter may be utilized for processing a preprocessed sound signal that is generated by the first remote end unit at a later time. According to an embodiment of the invention, step 590 includes step 594 of utilizing the updated echo reduction parameter for processing a preprocessed sound signal that is generated by the first remote end unit.

Referring now to FIG. 2B. As aforementioned, according to an embodiment of the invention, method 500 includes providing (following the determining of the echo reduction parameter in step 530) the echo reduction parameter to the first remote end unit (step 570) and receiving (prior to the transmitting of the processed sound sequence 470 to the second remote end unit in step 590) the processed sound sequence 470 from the first remote end unit.

It is noted that the first remote end unit may implement different methods of utilizing the echo reduction parameter for processing the preprocessed sound sequence 460 in order to reduce echo therefrom. It is noted that this utilizing (or echo reduction) may be carried out by software, by hardware, by firmware, and by any combination thereof.

According to an embodiment of the invention, the first remote end unit includes (or runs or hosts) a Flash based communication widget (as is known in the art, Adobe Flash is a technology that allows embedding ‘applets’ directly in web-pages; the application appears as part of the webpage that hosts it, and the user interacts with the flash applet as if it is an integrated part of the viewed webpage). Several of the embodiments of such a flash based communication widget are disclosed in U.S. patent application entitled “Method and system for providing communication” by the same inventors filed 30 Jun. 2009, which is incorporated herein by reference.

It is also noted that the first remote end unit and the intermediary communication unit may cooperate for reducing echo.

According to an embodiment of the invention, step 510 of transmitting includes stage 512 of transmitting multiple first sequence segments that include transmission timing metadata (e.g. separately or conjunctively, in at least one group of first sequence segments) that indicate transmission timing of the first sequence segments. That is, each first sequence segment may include, for example, timing information pertaining to the time in which that first sequence segment was sent from the intermediary communication system to the first remote end unit.

According to such an embodiment of the invention, stage 520 of receiving may include stage 522 of receiving multiple returning sequence segments that include (e.g. separately or conjunctively, in at least one group of returning sequence segments) return timing metadata that is incorporated into the returning sequence segments by the first remote end unit in response to the transmission timing metadata received by the first remote end unit.

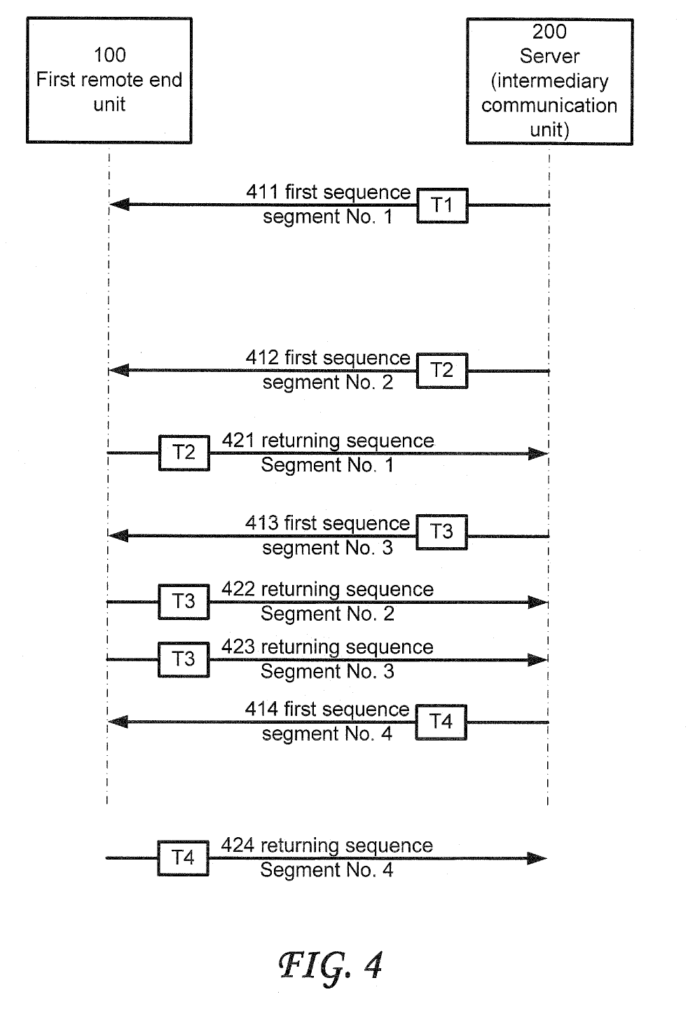

It is noted that the return timing metadata may not pertain to a transmission time of the returning sequence segments, but rather to the transmission time of the last first sequence segment that was received. In the example illustrated in FIG. 4, for example, there are four first sequence segments denoted 411 through 414, and four returning sequence segments denoted 421 through 424.

The boxes denoted T1 through T4 refer to different timing information. As could be seen, according to the embodiment of the invention exemplified in FIG. 4, the timing information that is sent in each returning sequence segment is the last timing information that was received in the first sequence segment received last by the first remote end unit.

According to an embodiment of the invention, the determining of the echo reduction parameter is responsive to a comparison between the return timing metadata and a reception timing of the returning sound sequence. According to an embodiment of the invention, step 530 includes step 532 of 532 determining the echo reduction parameter in response to a comparison between the return timing metadata and a reception timing of the returning sound sequence.

Thus, if a returning sequence segment includes timing information pertaining to a time that is ΔT′ prior to the time in which that returning sequence segment was actually received, it can possibly be assumed that the current delay is about ΔT′.

It is noted that, according to an embodiment of the invention, the first sequence segments are part of voice communication that is transmitted from the intermediary communication unit to the first remote end unit (for example, speaking of a user of the second remote end unit that is transmitted to the first remote end unit via the intermediary communication unit). The first sequence segments may also be, according to an embodiment of the invention, transmitted prior to any voice conversation, and may serve particularly for the determining of the echo reduction parameter.

It is noted that, according to an embodiment of the invention, the returning sequence segments are part of voice communication that is transmitted from the first remote end unit to the intermediary communication unit (for example, speaking of a user of the first remote end unit that is transmitted to the second remote end unit via the intermediary communication unit). The returning sequence segments may also be, according to an embodiment of the invention, transmitted prior to any voice conversation, and may serve particularly for the determining of the echo reduction parameter.

According to an embodiment of the invention, step 520 includes step 523 of receiving the returning sound sequence within a superimposed stream that is superimposed by the first remote end unit from first unit input sound that is detected by a first end unit microphone and from sound that is received by the first remote end unit from the intermediary communication system, wherein step 530 of determining the echo reduction parameter may be responsive to detecting of echo effects within the returning sound sequence (step 533).

For example, according to an embodiment of the invention, the first remote end unit may intentionally superimpose sound that is received at time with echoes of signals from previous time T₂ (that are detected by microphone 194 at time T₃), so that the intermediary communication unit may determine a delay ΔT″ between T₂ and T₃ (so that T₃=T₂+ΔT″) by analyzing the sound signal that is received from the first remote end unit. It is noted that the superimposed combined sound signal is usually not part of any voice communication between users of the first and/or the second remote end unit. It is noted that according to such an embodiment of the invention, the intermediary communication unit would usually transmit to the first remote end unit a dedicated sound sequence, that easily enables detection of echoes. (it is noted that according to an embodiment of the invention, a simple chirp sound sequence is utilized, wherein the difference between the two frequencies that are received in each moment in the superimposed sound signals).

It is noted that while steps 512, 522, and/or 532 may be carried out in an embodiment in which steps 570 and/or 580 are also carried out, this is not compulsory so.

It is noted that while steps 523 and/or 533 may be carried out in an embodiment in which steps 570 and/or 580 are also carried out, this is not compulsory so.

FIGS. 3A and 3B illustrate processes for reducing echo according to different embodiments of the invention. The processes are described in relation to FIGS. 2A and 2B.

FIG. 4 illustrates transmission of sound sequence segments, according to an embodiment of the invention.

Referring now to intermediary communication system 200 and to method 500, according to several embodiments of the invention. According to an embodiment of the invention, whenever a new call is accepted by intermediary communication system 200, it will place a ‘signature’ short audio track (first sound sequence 410, e.g. a 100 ms length or so sized audio file) into an audio stream that is directed toward first remote end unit 100 (which may be, for example, a flash based communication widget).

The ‘signature’ audio may contain, for example, signals that vary in amplitude and frequency in a way that can be easily distinguishable from carrier signal or common background noise.

Intermediary communication system 200 will then conveniently search for a representation of the ‘signature’ audio track in the audio stream that is returned from the client, and look for appearance of an audio sample which statistically resembles the original ‘signature’ audio that was transmitted.

If within a configurable timeout (usually up to 2-3 seconds) from the transmission of the first sound sequence original, no echo of that audio is found in the audio stream returned from first remote end unit, the connection is assumed, according to an embodiment of the invention, to have no traceable echo.

If within the configurable timeout above, a signal similar to the ‘signature’ sound (resembles the original sound with less than a defined threshold of errors), the connection is assumed, according to an embodiment of the invention, to have echo. In this case, intermediary communication system 200 extracts, according to an embodiment of the invention, one or more of the following echo reduction parameters, by comparing the transmitted sound to the received ‘echo’:
a. an average delay of echo at intermediary communication system 200 level can be deducted by subtracting the time of reception of probable echo with the time of transmission. This information can later be used to train latency based echo cancellation algorithms.
b. An attenuation of different frequency ranges/bands (that may result, for example, from effect of different codecs and electronic devices along the route of the signal) can be deducted and saved for tuning of echo cancellation.
c. A spectral diversion (frequency modulation coefficients for different frequency ranges) of the received signal with respect to the transmitted signal can be deducted.

It is noted that, according to an embodiment of the invention, intermediary communication unit 200, upon determining the at least one echo reduction parameter, may determine a component to carry out the echo reduction. It is noted that this component may for example by a communication module of intermediary communication system 200 that have given signal processing capabilities, and may also be an external system (e.g. another communication server) that may and may not be connected to and/or managed by intermediary communication system 200,

The information deducted from comparing transmitted and received signal may be used, according to an embodiment of the invention, to redirect calls that present ‘noticeable echo’ to a node or channel that supports hardware or software based echo reduction. This allows reducing CPU load on the different units that do not utilize (or utilize a lesser) echo reduction (as many calls would not present echo and echo cancellation is computationally intensive and requires significant additional CPU resources over handling calls that do not require echo canceling).

The echo reduction parameter determined by intermediary communication unit 200 may also be utilized, according to an embodiment of the invention, to tune echo cancellation algorithms that are based on latency, spectral diversion and/or attenuation bands so that echo canceling would become more effective and have less impact on signals not related to echo.

According to an embodiment of the invention, a unique approach for reducing echo from voice calls that are transported over RTMP to/from a flash-based voice call client is disclosed. It is noted that the flash based voice call client (or widget) may not be capable of reducing echo at the client software itself due to technical limitations of the client development platform.

According to such an embodiment of the invention, intermediary communication system 200 will add a timestamp (usually based on intermediary communication system 200 clock) as a protocol header field, to each sound sequence segment/voice chunk/packet that is transmitted from intermediary communication system 200 to the flash-based client (which conveniently acts as first remote end unit 100, or which runs on one).

Intermediary communication system 200 will maintain a data structure containing the timestamps of all sound sequence segments/voice chunks/packets it will have transmitted to first remote end unit 100. For each sound sequence segment/voice chunk/packet, intermediary communication system 200 will also store the total gain (volume) of audio transmitted from intermediary communication system 200 to the first remote end unit 100, or other audio parameter of such audio information.

The flash-based client (and/or first remote end unit 100) will write the LAST timestamp it has received (that would be the time of transmitting the packet according to intermediary communication system 200's clock) into the header of each sound sequence segment/voice chunk/packet of voice data it sends back to intermediary communication system 200.

Intermediary communication system 200 will examine the timestamp that appears in the header of each sound sequence segment/voice chunk/packet that is received from the client (and/or from first remote end unit 100).

Intermediary communication system 200 will lookup the audio parameter value from its internal data structure, based on the time of original transmission that will be extracted from the incoming packet's header. Intermediary communication system 200 will then lower the gain of the sound sequence segment/voice chunk/packet in response to the value of the audio parameter (e.g. reducing by the same amount before passing that packet or chunk of audio data to the other party).

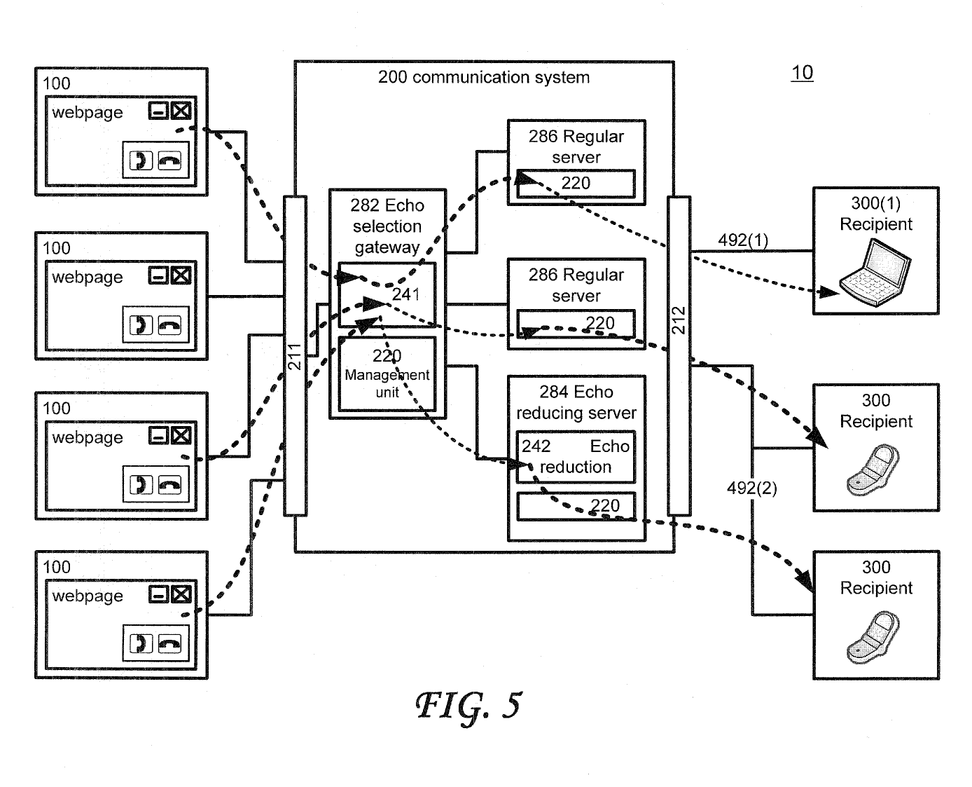

FIG. 5 illustrates system 10, according to an embodiment of the invention. It is noted that, according to an embodiment of the invention, several first remote end units 100 may be connected to intermediary communication system 200, and via which to one or more second remote end units 300. It is also noted that, according to an embodiment of the invention, several second remote end units 300 may be connected to intermediary communication system 200, and intermediary communication system 200 may connect between any first remote end unit 100 to a selected second remote end unit 300 out of the several second remote end units 300.

It is further noted that, according to an embodiment of the invention, intermediary communication system 200 may include multiple processing unit (e.g. multiple processors or processing cores) such as multiple communication servers, that form a structure in which each processing unit is connected to at least one other processing unit.

According to an embodiment of the invention, intermediary communication system 200 includes a signal evaluation unit 241 that is configured to evaluate a sound quality of voice communication with remote system 100 is included in a gateway of intermediary communication system 200 (E.g. echo selection gateway 282), and wherein the management unit is further configured to select a processing unit that will participate in a routing of the voice communication session in response to a result of the evaluating, wherein different processing unit of the intermediary communication system 200 have different sound processing capabilities.

It is noted that intermediary communication system 200 may implement different scenarios and decisions rules for determining an identity of second remote end unit 300, a preferred way to connect to second remote end unit 300 (e.g. try office VoIP software, then cellular number, then home phone number). Intermediary communication system 200 may also implement different scenarios and deciding rules for determining what to do if second remote end unit 300 can not be reached (e.g. leave a voice message, leave a text message, and so forth).

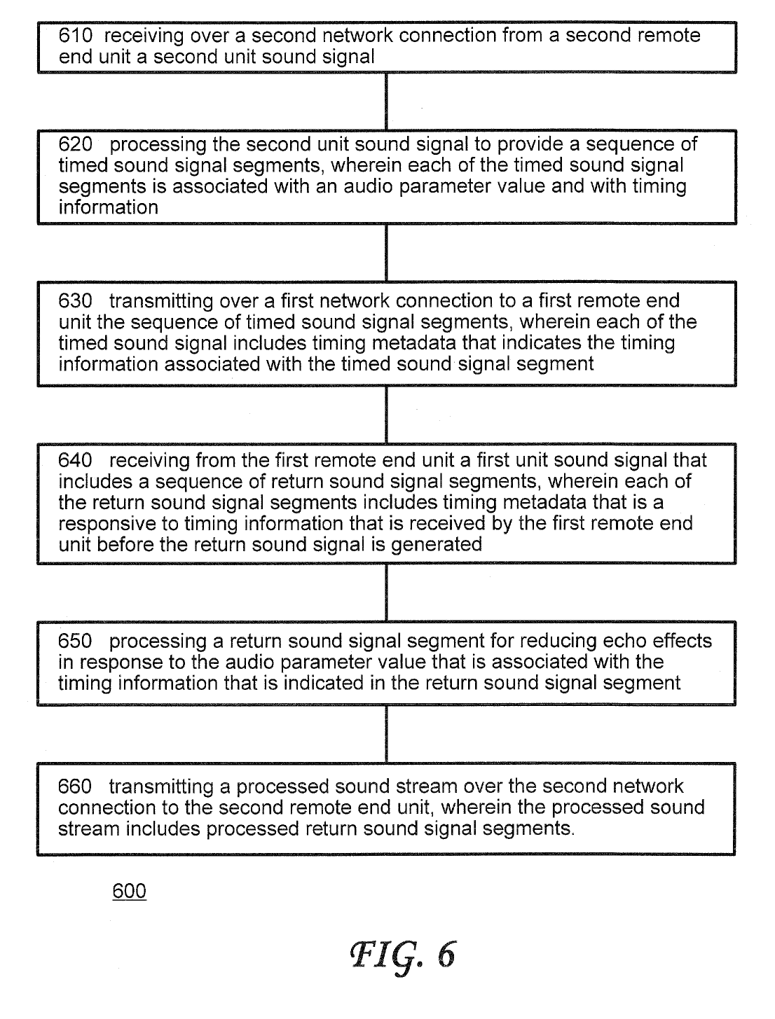

FIG. 6 illustrates method 600 for reducing echo, according to an embodiment of the invention. Referring to the examples set forth in the previous drawings, method 506 may be carried out according to an embodiment of the invention in a system such as system 10 of FIG. 1. It is noted that conveniently, all of the stages of method 600 (unless otherwise stated) are carried out by an intermediary communication system—such as a communication server—but this is not necessarily so.

Method 600 conveniently starts with step 610 of receiving over a second network connection from a second remote end unit a second unit sound signal.

Step 610 is followed by step 620 of processing the second unit sound signal to provide a sequence of timed sound signal segments, wherein each of the timed sound signal segments is associated with an audio parameter value and with timing information.

Step 620 is followed by step 630 of transmitting over a first network connection to a first remote end unit the sequence of timed sound signal segments, wherein each of the timed sound signal includes timing metadata that indicates the timing information associated with the timed sound signal segment.

Step 630 is followed by step 640 of receiving from the first remote end unit a first unit sound signal that includes a sequence of return sound signal segments, wherein each of the return sound signal segments includes timing metadata that is a responsive to timing information that is received by the first remote end unit before the return sound signal is generated.

Step 640 is followed by step 650 of processing a return sound signal segment for reducing echo effects in response to the audio parameter value that is associated with the timing information that is indicated in the return sound signal segment.

Step 650 is followed by step 660 of transmitting a processed sound stream over the second network connection to the second remote end unit, wherein the processed sound stream includes processed return sound signal segments.

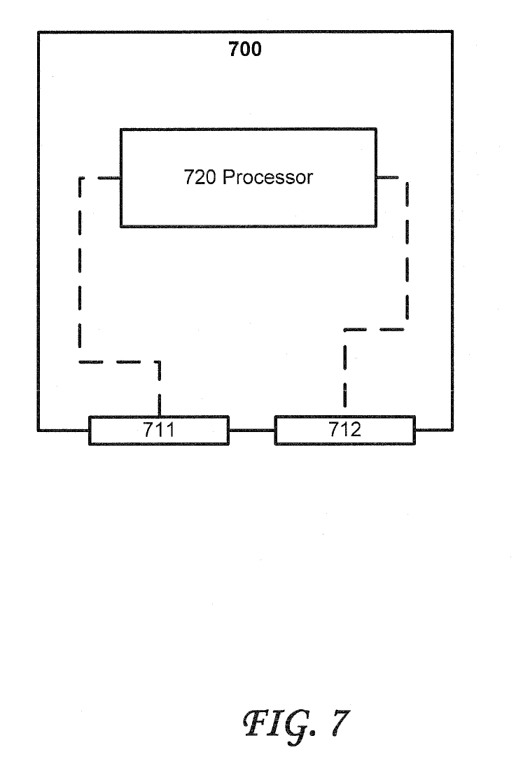

FIG. 7 illustrates system 700, according to an embodiment of the invention system 700 is conveniently adapted to reduce echo in voice communication.

System 700 includes a second network interface 712 configured for receiving over a second network connection from a second remote end unit a second unit sound signal.

System 700 further includes processor 720 configured to process the second unit sound signal to provide a sequence of timed sound signal segments, wherein each of the timed sound signal segments is associated with an audio parameter value and with timing information.

System 700 further includes first network interface 711 configured for transmitting over a first network connection to a first remote end unit the sequence of timed sound signal segments, wherein each of the timed sound signal includes timing metadata that indicates the timing information associated with the timed sound signal segment.

First network interface 711 is further configured for receiving from the first remote end unit a first unit sound signal that includes a sequence of return sound signal segments, wherein each of the return sound signal segments includes timing metadata that is a responsive to timing information that is received by the first remote end unit before the return sound signal is generated.

Processor 720 is further configured for processing a return sound signal segment for reducing echo effects in response to the audio parameter value that is associated with the timing information that is indicated in the return sound signal segment.

Second network interface 712 is further configured for transmitting a processed sound stream over the second network connection to the second remote end unit, wherein the processed sound stream includes processed return sound signal segments.

Referring to system 200, according to an embodiment of the invention, second network interface 212 is configured for receiving over second network connection 492 from second remote end unit 300 a second unit sound signal; wherein processor 220 is configured to process the second unit sound signal to provide a sequence of timed sound signal segments, wherein each of the timed sound signal segments is associated with an audio parameter value and with timing information; wherein first network interface 211 is configured for transmitting over first network connection 491 to first remote end unit 100 the sequence of timed sound signal segments, wherein each of the timed sound signal includes timing metadata that indicates the timing information associated with the timed sound signal segment; wherein first network interface 211 is further configured for receiving from first remote end unit 100 a first unit sound signal that includes a sequence of return sound signal segments, wherein each of the return sound signal segments includes timing metadata that is a responsive to timing information that is received by first remote end unit 100 before the return sound signal is generated; wherein processor 220 is further configured for processing a return sound signal segment for reducing echo effects in response to the audio parameter value that is associated with the timing information that is indicated in the return sound signal segment; wherein second network interface 212 is further configured for transmitting a processed sound stream over second network connection 492 to second remote end unit 300, wherein the processed sound stream includes processed return sound signal segments.

The present invention can be practiced by employing conventional tools, methodology and components. Accordingly, the details of such tools, component and methodology are not set forth herein in detail. In the previous descriptions, numerous specific details are set forth., in order to provide a thorough understanding of the present invention. However, it should be recognized that the present invention might be practiced without resorting to the details specifically set forth. Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

We claim:

1 An intermediary communication system, the intermediary communication comprising:
a first network interface, configured for transmitting over a first network connection to a first remote end unit a first sound sequence;
and for receiving from the first remote end unit a returning sound sequence that is responsive to the first sound sequence;
a processor, configured to determine an echo reduction parameter in response to a relationship between a first sound sequence parameter and a returning sound sequence parameter; and
a second network interface, configured for transmitting to a second remote end unit, over a second network connection, a processed sound sequence that was generated in response to the echo reduction parameter from a preprocessed sound sequence which was generated by the first remote end unit.

2. The intermediary communication system of claim 1, wherein the first network interface is further configured for transmitting the first sound sequence over at least one asynchronous packet switched network segment.

3. The intermediary communication system of claim 1, wherein processor is further configured to digitally process, prior to a receiving of the returning sound sequence, sound signals received in an incoming channel of the intermediary communication system, for detecting the returning sound sequence.

4. The intermediary communication system of claim 1, wherein a delay between a transmission of the first sound sequence and a reception of the returning sound sequence is not known prior to a determination of the echo reduction parameter by the processor.

5. The intermediary communication system of claim 1, wherein:
the processor is further configured to determine a delay period between a transmitting time of the first sound sequence and a reception time of the returning sound sequence;
wherein the first network interface is further for transmitting over the first network connection to the first remote end unit, prior to the transmitting of the processed sound sequence, a second sound sequence, after the determining of the delay period; and
wherein the processor is further configured to process the preprocessed sound sequence in response to the delay period and in response to the second sound sequence, to provide the processed sound sequence.

6. The intermediary communication system of claim 5, wherein the delay period is larger than 300 milliseconds.

7. The intermediary communication system of claim 5, wherein the second sound sequence is responsive to a sound sequence that is received from the second remote end unit.

8. The intermediary communication system of claim 1 further configured to prepare the processed sound sequence for transmission to a circuit switched telephony system remote end unit.

9. The intermediary communication system of claim 1, wherein the processor is further configured to periodically update, following a determining of the echo reduction parameter, the echo reduction parameter in response to an analysis of sound signal that is received from the first remote end unit, and wherein the processor is further configured to utilize the updated echo reduction parameter for processing a preprocessed sound signal that is generated by the first remote end unit.

10. The intermediary communication system of claim 1, wherein:
the first network interface is further for receiving the preprocessed sound sequence from the first remote end unit which does not perform echo reduction;
wherein the processor is further configured to process, prior to a transmitting of the processed sound sequence to the second remote end unit, the preprocessed sound sequence in response to the echo reduction parameter, to provide the processed sound sequence; and
wherein the second network interface is further for transmitting the processed sound sequence to the second remote end unit that does not perform echo reduction on the processed sound sequence.

11. The intermediary communication system of claim 1, further configured to provide the echo reduction parameter to the first remote end unit, and to receive the processed sound sequence from the first remote end unit prior to a transmitting of the processed sound sequence to the second remote end unit.

12. The intermediary communication system of claim 11, wherein:
the first network interface is further configured to transmit multiple first sequence segments that comprise transmission timing metadata that indicate transmission timing of the first sequence segments; and to receive multiple returning sequence segments that comprise return timing metadata that is incorporated into the returning sequence segments by the first remote end unit in response to the transmission timing metadata received by the first remote end unit;
wherein the processor is further configured to determine the echo reduction parameter in response to a comparison between the return timing metadata and a reception timing of the returning sound sequence.

13. The intermediary communication system of claim 11, wherein:
the first network interface is further configured to receive the returning sound sequence within a superimposed stream that is superimposed by the first remote end unit from first unit input sound that is detected by a first end unit microphone and from sound that is received by the first remote end unit from the intermediary communication system; and
wherein the processor is further configured to determine the echo reduction parameter in response to a detecting of echo effects within the returning sound sequence.

14. A method for reducing echo, the method comprising carrying out by an intermediary communication system the following steps:
transmitting to a first remote end unit a first sound sequence over a first network connection;
receiving from the first remote end unit a returning sound sequence that is responsive to the first sound sequence;
determining an echo reduction parameter in response to a relationship between a first sound sequence parameter and a returning sound sequence parameter; and
transmitting to a second remote end unit, over a second network connection, a processed sound sequence that was generated in response to the echo reduction parameter from a preprocessed sound sequence which was generated by the first remote end unit.

15. The method of claim 14, wherein the transmitting of the first sound sequence comprises transmitting the first sound sequence over at least one asynchronous packet switched network segment.

16. The method of claim 14, wherein the receiving of the returning sound sequence is preceded by digitally processing sound signals received in an incoming channel of the intermediary communication system, for detecting the returning sound sequence.

17. The method of claim 14, wherein a delay between the transmitting of the first sound sequence and the receiving of the returning sound sequence is not known prior to the determining of the echo reduction parameter.

18. The method of claim 14, wherein:
the determining comprises determining a delay period between a transmitting time of the first sound sequence and a reception time of the returning sound sequence;
wherein the transmitting of the processed sound sequence is preceded by transmitting over the first network connection to the first remote end unit a second sound sequence, after the determining of the delay period; and
wherein the method further comprises processing, by the intermediary communication system, the preprocessed sound sequence in response to the delay period and in response to the second sound sequence, to provide the processed sound sequence.

19. The method of claim 18, wherein the determining of the delay period comprises determining a delay period that is larger than 300 milliseconds.

20. The method of claim 18, wherein the transmitting of the second sound sequence comprises transmitting the second sound sequence which is responsive to a sound sequence that is received from the second remote end unit.

21. The method of claim 14, wherein the transmitting of the processed sound sequence comprises preparing the processed sound sequence for transmission to a circuit switched telephony system remote end unit.

22. The method of claim 14, wherein the determining of the echo reduction parameter is followed by periodically updating the echo reduction parameter in response to an analysis of sound signal that is received from the first remote end unit, and utilizing the updated echo reduction parameter for processing a preprocessed sound signal that is generated by the first remote end unit.

23. The method of claim 14, wherein the transmitting of the processed sound sequence is preceded by:
receiving the preprocessed sound sequence from the first remote end unit which does not perform echo reduction; and
processing, by the intermediary communication system, the preprocessed sound sequence in response to the echo reduction parameter, to provide the processed sound sequence;
wherein the transmitting of the processed sound sequence comprises transmitting the processed sound sequence to the second remote end unit that does not perform echo reduction on the processed sound sequence.

24. The method of claim 14, wherein the determining of the echo reduction parameter is followed by providing the echo reduction parameter to the first remote end unit, and wherein the transmitting of the processed sound sequence to the second remote end unit is preceded by receiving the processed sound sequence from the first remote end unit.

25. The method of claim 24, wherein:
the transmitting of the first sound sequence comprises transmitting multiple first sequence segments that comprise transmission timing metadata that indicate transmission timing of the first sequence segments;
wherein the receiving of the returning sound sequence comprises receiving multiple returning sequence segments that comprise return timing metadata that is incorporated into the returning sequence segments by the first remote end unit in response to the transmission timing metadata received by the first remote end unit;
wherein the determining of the echo reduction parameter is responsive to a comparison between the return timing metadata and a reception timing of the returning sound sequence.

26. The method of claim 24, wherein:
the receiving of the returning sound sequence comprises receiving the returning sound sequence within a superimposed stream that is superimposed by the first remote end unit from first unit input sound that is detected by a first end unit microphone and from sound that is received by the first remote end unit from the intermediary communication system;
wherein the determining of the echo reduction parameter is responsive to detecting of echo effects within the returning sound sequence.

27. A method for reducing echo, the method comprising carrying out by an intermediary communication system the following steps:
receiving over a second network connection from a second remote end unit a second unit sound signal;
processing the second unit sound signal to provide a sequence of timed sound signal segments, wherein each of the timed sound signal segments is associated with an audio parameter value and with timing information;
transmitting over a first network connection to a first remote end unit the sequence of timed sound signal segments, wherein each of the timed sound signal comprises timing metadata that indicates the timing information associated with the timed sound signal segment;
receiving from the first remote end unit a first unit sound signal that comprises a sequence of return sound signal segments, wherein each of the return sound signal segments comprises timing metadata that is a responsive to timing information that is received by the first remote end unit before the return sound signal is generated;
processing a return sound signal segment for reducing echo effects in response to the audio parameter value that is associated with the timing information that is indicated in the return sound signal segment; and transmitting a processed sound stream over the second network connection to the second remote end unit, wherein the processed sound stream comprises processed return sound signal segments.
